(19) United States
(12) Patent Application Publication
(10) Pub. No.: US 2011/0268836 A1
(43) Pub. Date: Nov. 3, 2011

(54) FOOD COMPOSITIONS

(76) Inventor: ALESSANDRO SENECI, MILAN (IT)

(21) Appl. No.: 13/116,243

(22) Filed: May 26, 2011

Related U.S. Application Data
(63) Continuation-in-part of application No. 11/568,586, filed on Nov. 2, 2006, now abandoned.

(30) Foreign Application Priority Data
May 12, 2004 (IT) MI2004A000956

(51) Int. Cl. A23L 1/052; A23L 1/16; A23L 1/0524; A23L 1/0526; A23G 3/36; A23L 1/0528; A23L 1/0534; A23C 9/123; A23L 1/10; A21D 13/00; A23L 1/053

(52) U.S. Cl. 426/2; 426/573; 426/549; 426/557; 426/442; 426/577

(57) ABSTRACT

A foodstuff composition is described which contains from 50 to 90% by weight of inulin or fructooligosaccharides, from 10 to 40% by weight of gelling fibres, and from 1 to 10% by weight of water-insoluble fibres. This composition may be mixed with soft wheat flour and/or durum wheat flour and used as an alternative to flour for the preparation of food products for the purpose of reducing the glycaemic peak.

This application is a continuation-in-part of and claims priority to application Ser. No. 11/568,586, which is the U.S. National Phase of International Application No. PCT/IT05/00266, filed May 6, 2005, which claims priority to Italian Patent Application MI2004A000956, filed May 12, 2004. The contents of these prior applications are herein incorporated by reference and priority to the filing date accorded to each is hereby claimed.

The present invention relates to a novel foodstuff composition capable of reducing the glycaemic, insulinaemic and/or lipaemic peak after the ingestion of monosaccharides, disaccharides, polysaccharides, lipids and proteins contained therein and contained in the food which may accompany the ingestion thereof; the composition is also capable of introducing soluble fibres having a probiotic effect for the re-balancing and nourishing of bacterial flora. The composition also reduces the glycaemic index of food prepared therewith.

Glycaemic peak according to the invention represents the sudden increase of glycemia, and the consequent sudden insulin release after the ingestion of food products with an high glycaemic index.

Glycaemic index according to the invention is defined as the incremental area under the blood glucose response curve (iAUC) of a 50 g carbohydrate portion of a test food expressed as a percent of the response to the same amount of carbohydrate from a standard food (white bread or glucose) taken by the same subject.

It is well known in the art that diet using food products with a low glycaemic index has a potential effect in preventing and/or treating not only diabetic subjects, in which an improvement of the insulin sensitivity is determined with significatively reductions of the basal glycemia and glycosylate hemoglobin values, but also in subjects affected by dyslipidemia, and even in healthy subjects reducing the cholesterol and tryglicerides levels, improving the insulin sensitivity.

The foodstuff composition of the invention is thus able to improve the insulin sensitivity and the carbohydrate metabolism in person fed with food products containing thereof, preferably when being on a diet.

Insulin sensitivity according to the invention refers to the levels of insulin required in a subject for processing glucose. In diabetics, or in people with insulin-resistance, an high amount of insulin is necessary for processing glucose leading to well known health disorders and/or pathologies.

Moreover, the foodstuff composition of the invention allows to produce food products of optimal palatability and organoleptic composition. In particular, the addition of the foodstaff composition of the invention (hereinafter “brake”) to food products and/or bases for producing food products as, for example, flours, semolina, bases for pizza, pizza, yogurt, cereals, and bakery products not only it does not alter, but it also improves, the taste and palatability of said products compared to the same reference products without the brake.

The term “palatability” according to the present invention refers to the taste and/or the pleasantness of a food, a foodstuff, a food product or a substance to be taken by oral route. This aspect is of particular relevance in alimentary field, particularly in case of dietetics since the most part of patients, or person involved in a diet, want or need to reduce their glycaemic, insulinaemic and/or lipaemic peak without renouncing to taste and pleasantness.

The optimal taste and palatability of the products guarantees a better sensation in the mouth and, therefore, enhance an optimal salivation with an improvement of the fibres' hydratation and action. Many products on the market rich in fibres have, indeed, a bad taste and palatability so are immediately swallowed, with a shorter time of permanency in the mouth, and therefore a lower fibers' hydratation and action.

It is therefore present in this field the need to provide products capable of reducing the glycaemic, insulinaemic and/or lipaemic peak their ingestion also having tasty and charming characteristics.

The foodstuff composition according to the present invention is preferably in the form of a powder and can be used in addition to flour and any other bases for the preparation of food products, such as, for example, bread, baked goods, pasta, biscuits, confectionery, yogurt, cereals, etc.; in particular, approximately 65% by weight of the composition has a granulometry of less than 25 mesh, approximately 20% has a granulometry greater than 25 mesh, approximately 15% has a granulometry greater than 22 mesh, and approximately 1% has a granulometry greater than 19 mesh.

The composition according to the present invention contains from 50 to 90% by weight of inulin or fructooligosaccharides, from 10 to 40% by weight of gelling fibres, from 1 to 10% by weight of water-insoluble fibres, and from 0.5 to 2% by weight of at least one polysaccharide, with respect to the total weight of the composition (that is to say, where the sum of the individual components comes to 100).

Polysaccharide according to the present invention is preferably chitosan. Chitosan according to the present invention is a linear polysaccharide made of D-glucosamine and N-acetyl-D-glucosamine, linked by β(1-4) bonds. Chitosan is normally formed by treating chitin, generally obtained from crustacean's exoskeleton (crabs, for example) with an aqueous basic solution.

The gelling fibre is preferably selected from glucomannan, guar gum, karaya gum, psyllium fibre, acacia fibre and/or pectin; the insoluble fibre is preferably selected from wheat fibre, cellulose, hemicellulose and/or lignin, the cellulose preferably being in microcrystalline form.

According to a first preferred aspect of the invention, the composition contains from 60 to 80% by weight of inulin or fructooligosaccharides, preferably from 65 to 75% by weight, and even more preferably approximately 70% by weight.

According to a second preferred aspect of the invention, the composition contains from 15 to 35% by weight of gelling fibres, preferably from 20 to 30% by weight, and even more preferably approximately 25% by weight.

According to a third preferred aspect of the invention, the composition contains from 3 to 7% by weight of insoluble fibre, preferably from 4 to 6% by weight, and even more preferably approximately 5% by weight.

According to a fourth preferred aspect of the invention, the composition contains from 0.5 to 2% by weight of at least one polysaccharide, more preferably about 1.5% by weight.

It should be emphasized that all of the fibres that can be used for the invention, that is to say, soluble and insoluble fibres, may be used as such or in their naturally occurring non-purified form. For example, inulin may be used in the form of chicory fibre, pectin in the form of apple and/or orange fibre, and cellulose in the form of wheat and/or oat fibre, etc.

According to the preferred aspect of the invention, the foodstuff composition is constituted by 70% by weight of inulin, 5% by weight of glucomannan, 20% by weight of guar gum and 5% by weight of wheat fibre.

According to a further preferred aspect of the invention, the foodstuff composition is constituted by 70% by weight of inulin, 5% by weight of glucomannan, 20% by weight of guar gum, 3.5% by weight of wheat fibre and 1.5% of chitosan.

As mentioned above, the foodstuff composition according to the present invention can be used in admixture with soft wheat flour and/or durum wheat flour for the preparation of food products, such as, for example, bread, baked goods, pasta, biscuits, confectionery, pizza, cereals, etc.

For that purpose, 2-8 parts by weight of foodstuff composition can be mixed with 40-60 parts by weight of soft wheat flour and/or durum wheat flour; according to a preferred aspect, 4-6 parts by weight of composition, preferably 4.5-5.5, and even more preferably approximately 5, are mixed with 44-56, preferably 48-52, and even more preferably approximately 50 parts by weight of flour.

For the purposes of the present invention, the percentages are to be understood as percentages by weight with respect to the total weight of the composition. According to a preferred aspect, the composition according to the present invention comprises inulin and/or fructooligosaccharides, gelling fibres, water-insoluble fibres and polysaccharides in the ratios by weight indicated above.

The foodstuff composition of the present invention is preferably used for preparing alimentary products, food products and others to be used in diets, more preferably isocaloric diets.

The term “isocaloric diets” according to the present invention refers to a moderate-carbohydrate, moderate-fat diet that allows people to eat whatever they want as long as they consume the same amount of carbohydrates, proteins and fats daily.

A first object of the present invention is therefore a foodstuff composition according to the above, and as above described.

A second object of the present invention is therefore a method for reducing the glycaemic, insulinaemic and/or lipaemic peak which comprise the consumption of food products containing the foodstuff composition of the invention (“braked products”, i.e. food products containing the “brake”).

A third object of the present invention is therefore a method for preparing food products with low glycaemic index which comprise the preparation of food products using the foodstuff composition of the invention (“brake”) during the preparation of said food products (“braked products”)

A fourth object of the present invention is therefore a method for improving the palatability of food products which comprise using the foodstuff composition of the invention (“brake”) during the preparation of said food products (“braked products”).

### EXPERIMENTAL SECTION

### Part 1: Reduction of the Glycaemic Peak

A foodstuff composition according to the present invention (hereinafter indicated by the term “brake”), and having the qualitative-quantitative composition indicated hereinafter was used to evaluate the reduction in the glycaemic peak resulting from the consumption of biscuits with respect to a reference standard:
inulin: 70% by weight;
glucomannan: 5% by weight;
guar gum: 20% by weight;
wheat fibre: 5% by weight.

The composition of the “braked” biscuits, that is to say, containing the “brake” according to the present invention, is shown hereinafter together with that of the comparison biscuits not containing any “brake”.

| | | | Quantity | Quantity |
|---|---|---|---|---|
| | % by | | normal | “braked” |
| grams | weight | Product | biscuit | biscuit |
| 5800 | 54.00 | Soft wheat flour + | 2900 | 2510 |
| | | 13.5% of brake by gross | | 390 |
| | | weight | | |
| 2200 | 20.50 | Butter | 1200 | 1200 |
| 2000 | 18.60 | Caster sugar | 1000 | 1000 |
| 360 | 3.40 | Large whole eggs (No. 3) | 178 | 180 |
| 370 | 3.50 | Egg yolks | 182 | 182 |
| 2 | 0.02 | Vanilla flavouring | 1 | 1 |
| 4 | 0.04 | Lemon flavouring | 2 | 2 |
| Total | 100.06 | Yield-15% after baking | 5463 | 5465 |
| | | in a fan oven at 210° C. | 4300 | 4900 |
| | | for 13 minutes | | |

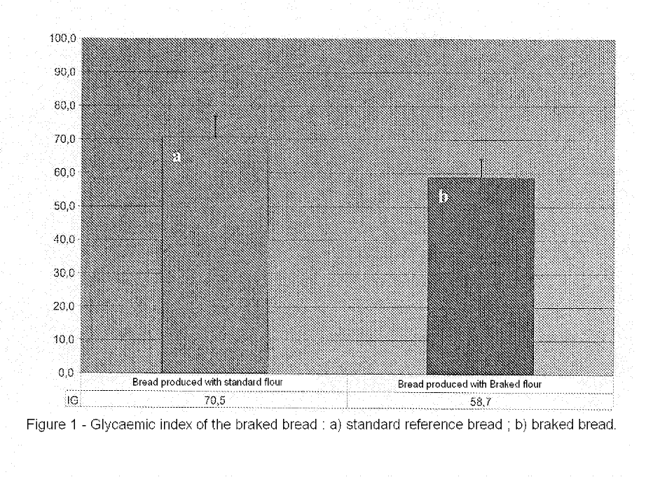

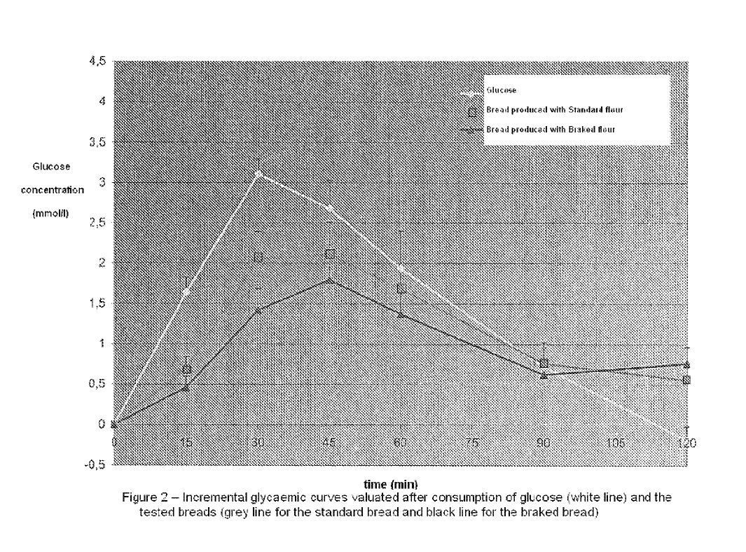

The “braked” biscuits and the control biscuits not containing any “brake”, were administered to 10 healthy volunteers whose glycaemic levels were measured compared with a reference standard based on pure glucose. The results are shown in FIGS. 1 and 2 (where the “braked” biscuit is indicated as “biscuit+fibre”). FIG. 1, in particular, shows the glycaemic levels compared with the reference standard; FIG. 2 on the other hand shows only the glycaemic levels resulting from the consumption of the biscuits. As will be readily appreciated, the presence in the biscuits of the composition according to the invention permits a reduction in the glycaemic index of 42.5% in the “braked” biscuit compared with the normal biscuit.

### Part 2: Evaluation of the Reduction of the Glycaemic Index in Braked Bread

A foodstuff composition according to the present invention (hereinafter indicated by the term “brake”), and having the qualitative-quantitative composition indicated hereinafter was used to evaluate the reduction in the glycaemic index resulting from the consumption of bread containing it (braked bread) with respect to a reference standard:
inulin: 70% by weight;
glucomannan: 5% by weight;
guar gum: 20% by weight;
wheat fibre: 5% by weight.

The glycaemic index evaluation has been carried on according to the Standardized procedure FAO/WHO 1998.

Ten (10) healthy adult subjects have been enrolled, 5 women and e males, with average age between 20 and 25 years old. Each of them had, in randomized order, 5 test meals (2 breads+three repetitions of reference (50 g in 500 mL of natural water).

The parts of test food have been calculated in order to administrate to the subjects 50 g of available carbohydrates (bread produced with Standard flour=100 g; bread produced with Braked flour=120 g) and accompanied with 500 mL of natural water.

The day of the experiment, the volunteers, without food from at least 8 hours, have been subjected to capillary blood sampling, before and after having the test food (times 0, 15, 30, 45, 60, and 120 minutes), with adapted devices (GLUCOLET, Bayer Diagnostics). The blood samples have been collected in appropriate vials (MICROVETTE CB-300, SARSTEDT, Germany) and stored at −18° C. until the glucose determination, performed by enzymatic route with a clinic analyzer of glucose (model STAT 2300 YSI). During the whole experimentation (about two hours each session) the volunteers did not smoked and did not have food or beverages, except for water.

At the test time, to the subjects a questionnaire has been consigned wherein age, weight, height, meal composition of the evening preceding the test, the modifications of the daily routine and the possible drugs and/or integrator assumption have been annotated.

For each subject, and for each meal, the incremental area (IAUC) under the postprandial glycaemic curves have been evaluated. The glycaemic index (GI) has been calculated as:

IG=(IAUCₜₑₛₜ/IAUCₛₜ)×100

wherein:
IAUCₜₑₛₜ=incremental glycaemic area of the food to be tested
IAUCₛₜ=average of the incremental glycaemic areas of the two test performed using the aqueous solution of glucose as Standard reference.

### Results:

As will be readily appreciated in the file attached, the presence in the bread of the composition according to the invention permits a reduction in the glycaemic index of 17% in the “braked” bread compared with the normal bread, see FIGS. 1 and 2 here-below reported.

### Conclusions:

From the obtained results of the above test it is demonstrated that the use of the composition of the invention (brake) in the preparation of bread allows the braked bread to significatively decrease the glycaemic index in subjects fed with it.

### Part 3: Improvement of Insulinic Sensitivity and of Carbohydrate Metabolism

A foodstuff compositions according to the present invention (hereinafter indicated by the term “brake”), and having the qualitative-quantitative composition indicated hereinafter was used to evaluate the improvement of insulinic sensitivity and of carbohydrate metabolism, thanks to an isocaloric diet based on biscuits, bread and pasta (for example, fresh tagliatelle) with respect to a reference standard:
inulin: 70% by weight;
glucomannan: 5% by weight;
guar gum: 20% by weight;
wheat fibre: 5% by weight

### Experimental Design of the Study

The experimental design is monocentric, randomized and cross-over, and comprises two treatment periods.

30 healthy patients have been subjected to an isocaloric diet for two treatment periods of four weeks each.

During the first treatment period, patients followed an isocaloric diet based on braked products (biscuits, bread and pasta (fresh tagliatelle) containing the composition of the invention “brake”).

During the second treatment period, patients followed an isocaloric diet based on reference products without brake.

### Analytical Methods Used in the Clinical Trial:

Metabolic and hormonal evaluation:

The following assays have been carried out: glycaemia, free fatty acids, total cholesterol, HDL cholesterol, triglycerides with a spectrophotometric assay adapted to COBAS Mira.
Insulinemia and fructosamine assay through the use of commercial kits.
Bio-impedance analysis (TANITA-BC-420-MA):
   the test have been carried out at t0, after four weeks of isocaloric diet based on reference products without brake.

### Results

An improvement of about 25% over basal of carbohydrates metabolism and of insulinic sensitivity through an isocaloric diet based on braked products (biscuits, bread and pasta (fresh tagliatelle) containing the composition of the invention “brake, compared to an isocaloric diet based on common products (biscuits, bread and pasta (fresh tagliatelle) has been recorded.

In addition, patients were given a questionnaire, in order to compare the palatability and possible organoleptic differences between braked products and reference products (i.e. comparing the products containing the composition of the invention “brake” vs the common product of the market without the “brake”).

The results surprisingly showed that the braked products (i.e. containing the composition of the invention “brake”) possess improved organoleptic properties and improved palatability when compared to the reference products. The improved palatability was confirmed by improved taste and pleasantness of each product with respect to the corresponding reference product.

1. A foodstuff composition containing from 50 to 90% by weight of inulin or fructooligosaccharides, from 10 to 40% by weight of gelling fibres, and from 1 to 10% by weight of water-insoluble fibres, with respect to the total weight of the composition.

2. The foodstuff composition according to claim 1, characterized in that the gelling fibre is selected from glucomannan, guar gum, karaya gum, psyllium fibre, acacia fibre and/or pectin.

3. The foodstuff composition according to claim 1, characterized in that the insoluble fibre is selected from wheat fibre, cellulose, hemi-cellulose and/or lignin.

4. The foodstuff composition according to claim 3, characterized in that the cellulose is in microcrystalline form.

5. The foodstuff composition according to claim 1, characterized in that it contains from 60 to 80% by weight of inulin or fructooligosaccharides.

6. The foodstuff composition according to claim 1, characterized in that it contains from 65 to 75% by weight of inulin or fructooligosaccharides.

7. The foodstuff composition according to claim 1, characterized in that it contains approximately 70% by weight of inulin or fructooligosaccharides.

8. The foodstuff composition according to claim 1, characterized in that it contains from 15 to 35% by weight of gelling fibres.

9. The foodstuff composition according to claim 1, characterized in that it contains from 20 to 30% by weight of gelling fibres.

10. The foodstuff composition according to claim 1, characterized in that it contains approximately 25% by weight of gelling fibres.

11. The foodstuff composition according to claim 1, characterized in that it contains from 3 to 7% by weight of insoluble fibres.

12. The foodstuff composition according to claim 1, characterized in that it contains from 4 to 6% by weight of insoluble fibres.

13. The foodstuff composition according to claim 1, characterized in that it contains approximately 5% by weight of insoluble fibres.

14. The foodstuff composition according to claim 1, characterized in that it further contains from 0.5 to 2% by weight of at least one polysaccharide, approximately 1.5% by weight of said at least one polysaccharide.

15. The foodstuff composition according to claim 1, characterized in that said at least polysaccharide is chitosan.

16. The foodstuff composition according to claim 1, characterized in that it contains approximately 70% by weight of inulin, approximately 5% by weight of glucomannan, approximately 20% by weight of guar gum and approximately 5% by weight of wheat fibre.

17. The foodstuff composition of claim 1, wherein said foodstuff composition comprises 2-8 parts by weight of a first component comprising said from 50 to 90% by weight of inulin or fructooligosaccharides, said from 10 to 40% by weight of gelling fibres, and said from 1 to 10% by weight of water-insoluble fibres, wherein said foodstuff composition comprises a second component, wherein said second component comprises 40-60 parts by weight of said foodstuff composition, wherein said second component comprises a soft wheat flour and/or durum wheat flour.

18. The foodstuff composition of claim 17, wherein said first component comprises 4-6 parts by weight of said foodstuff composition.

19. The foodstuff composition of claim 17, wherein said second component comprises 44-56 parts by weight of said foodstuff composition.

20. The foodstuff composition of claim 17, wherein said first component comprises 4.5-5.5 parts by weight of said foodstuff composition, and wherein said foodstuff composition comprises 48-52 parts by weight of soft wheat flour and/or durum wheat flour.

21. The foodstuff composition of claim 21, wherein said first component comprises approximately 5 parts by weight of said foodstuff composition.

22. The foodstuff composition of claim 21 wherein said second component of said foodstuff composition comprises approximately 50 parts by weight of said foodstuff composition.

23. The foodstuff composition of claim 1, wherein said foodstuff is incorporated into a food product.

24. The foodstuff composition of claim 17, wherein said foodstuff is incorporated into a food product.

25. The foodstuff composition of claim 23, wherein said food products is selected from the group consisting of bread, baked goods, pasta, biscuits, confectionery goods, yogurt, pizza and cereals.

26. The foodstuff composition of claim 24, wherein said food products is selected from the group consisting of bread, baked goods, pasta, biscuits, confectionery goods, yogurt, pizza and cereals.

27. The foodstuff composition of claim 27, wherein said food product is characterized in that said food product has an improved palatability.

28. A method of preparing a food product, wherein said food product comprises a foodstuff composition containing from 50 to 90% by weight of inulin or fructooligosaccharides, from 10 to 40% by weight of gelling fibres, and from 1 to 10% by weight of water-insoluble fibres, with respect to the total weight of said foodstuff composition.

29. A method of use of a foodstuff composition or a food product comprising a foodstuff composition containing from 50 to 90% by weight of inulin or fructooligosaccharides, from 10 to 40% by weight of gelling fibres, and from 1 to 10% by weight of water-insoluble fibres, with respect to the total weight of said foodstuff composition, for the reduction of the glycaemic, insulinaemic and/or lipaemic peak caused by the consumption of monosaccharides, disaccharides, polysaccharides, lipids and/or proteins.
